(19) United States
(12) Patent Application Publication
(10) Pub. No.: US 2026/0104620 A1
(43) Pub. Date: Apr. 16, 2026

(54) SILICON MACH-ZEHNDER MODULATOR-BASED PHOTONIC RF MIXER

(71) Applicant: INDUSTRY-ACADEMIC COOPERATION FOUNDATION, YONSEI UNIVERSITY, Seoul (KR)

(72) Inventors: Woo Young CHOI, Seoul (KR); Min Hyeok SEONG, Seongnam-si (KR)

(21) Appl. No.: 19/351,422

(22) Filed: Oct. 7, 2025

(30) Foreign Application Priority Data
Oct. 15, 2024 (KR) 10-2024-0140032

(51) Int. Cl. G02F 1/225; G02F 1/21

(52) U.S. Cl. CPC G02F 1/2255; G02F 1/212

(57) ABSTRACT

A silicon Mach-Zehnder modulator-based photonic RF mixer according to an embodiment includes a stacked structure of a plurality of silicon lamination parts and a plurality of metal lamination parts, wherein the plurality of silicon lamination parts are connected to an optical splitter and an optical coupler at both ends, respectively, and the metal lamination parts include: a first metal layer, which is a layer through which an RF signal is guided; a second metal layer, which is a layer through which an LO signal is guided; and a third metal layer, which is a layer through which a ground is connected.

### CROSS REFERENCE TO RELATED APPLICATION

The present application claims priority to Korean Patent Application No. 10-2024-0140032, filed October 15, 2024, the entire contents of which are incorporated here for all purposes by this reference.

### BACKGROUND

The disclosure relates to a silicon Mach-Zehnder modulator-based photonic RF mixer, and more particularly, to a silicon Mach-Zehnder modulator-based photonic RF mixer capable of reducing bias dependence and maintaining similar conversion gain.

The integration of microwave and optical systems has recently gained attention in the communications field. This integration holds promise for a variety of applications, including military, commercial vehicle, and aerospace communications. In particular, photonic RF mixers, which enable optical downconversion or upconversion of RF signals, are attracting attention. This technology offers signal isolation, linearity, spectral agility, and efficiency, and offers a solution to bandwidth bottlenecks in electronic signal processing.

Photonic RF mixers play a crucial role in converting electrical signals into optical signals, one of which is the Mach-Zehnder modulator (MZM). Conventional photonic RF mixers using Mach-Zehnder modulators operate by inputting the RF signal and LO (local oscillator) signal into separate waveguides. However, this approach suffers from the drawback that the output of the IF (intermediate frequency) signal varies significantly depending on the bias of the Mach-Zehnder modulator.

In other words, in the case of the conventional technology, the power of the IF signal varies greatly depending on the bias position of the Mach-Zehnder modulator, which means that the conversion gain of the RF mixer is greatly dependent on the bias, and due to this limitation, there is a problem that the bias adjustment for using the RF mixer becomes complicated and the cost increases.

### Related art document

### Patent document

Korean Patent Publication No. 10-2023-0050338

### SUMMARY

An embodiment of the disclosure provides a silicon Mach-Zehnder modulator-based photonic RF mixer capable of reducing bias dependence and maintaining similar conversion gain.

Furthermore, an embodiment of the disclosure provides a silicon Mach-Zehnder modulator-based photonic RF mixer capable of easily adjusting the bias because the RF signal and LO signal can be stably guided in separate metal layers.

Furthermore, an embodiment of the disclosure provides a silicon Mach-Zehnder modulator-based photonic RF mixer capable of providing more reliable signal output by being less affected by the optical bias of the Mach-Zehnder modulator even when harmonic components of the RF signal and LO signal are generated.

According to an aspect of the disclosure, a silicon Mach-Zehnder modulator-based photonic RF mixer is provided. The silicon Mach-Zehnder modulator-based photonic RF mixer includes a stacked structure of a plurality of silicon lamination parts and a plurality of metal lamination parts, wherein the plurality of silicon lamination parts are connected to an optical splitter and an optical coupler at both ends, respectively, and the metal lamination parts comprise: a first metal layer, which is a layer through which an RF signal is guided; a second metal layer, which is a layer through which an LO signal is guided; and a third metal layer, which is a layer through which a ground is connected.

The plurality of silicon lamination parts may include: a first silicon layer, which is a silicon layer doped with N; a second silicon layer, which is a silicon layer doped with P; and a third silicon layer, which forms an optical waveguide using the surfaces where the first and second silicon layers contact each other, wherein the third silicon layer is connected to the optical splitter and the optical coupler at both ends, respectively.

The first silicon layer may be formed by mixing a Group 5 impurity with silicon, the second silicon layer may be formed by mixing a Group 3 impurity with silicon, and the silicon lamination part may be stacked in an NPN configuration in the form of a first silicon layer - a second silicon layer - a first silicon layer, or in a PNP configuration in the form of a second silicon layer - a first silicon layer - a second silicon layer.

If the silicon lamination part is of the NPN configuration, the first metal layer may be provided on the upper side of the first silicon layer, and if the silicon lamination part is of the PNP configuration, the first metal layer may be provided on the upper side of the first second silicon layer, and the first metal layer may be connected to the silicon layer located underneath by a metal contact.

If the silicon lamination part is of the NPN configuration, the second metal layer may be provided between the first silicon layer and the second silicon layer, and if the silicon lamination part is of the PNP configuration, the second metal layer may be provided between the first second silicon layer and the first silicon layer, and the second metal layer is connected to the silicon layer located underneath by a metal contact.

Only RF signals are input to the first metal layer, and a bias star may be connected to one side of the second metal layer so as to enable DC voltage and LO signals to be input simultaneously to the second metal layer.

If the silicon lamination part is of the NPN configuration, the third metal layer may be provided on the upper part of the second first silicon layer, and if the silicon lamination part is of the PNP configuration, the third metal layer may be provided on the upper part of the second silicon layer, and the third metal layer may be connected to the silicon layer located underneath by a metal contact.

The third metal layer may be further provided between the first metal layer and the second metal layer.

A silicon Mach-Zehnder modulator-based photonic RF mixer according to an embodiment of the disclosure has an effect of reducing bias dependence and maintaining similar conversion gain.

Furthermore, a silicon Mach-Zehnder modulator-based photonic RF mixer according to an embodiment of the disclosure allows the RF signal and LO signal to be stably guided through separate metal layers, facilitating easy bias control.

Furthermore, a silicon Mach-Zehnder modulator-based photonic RF mixer according to ab embodiment of the disclosure is less affected by the optical bias of the Mach-Zehnder modulator even when harmonic components of the RF signal and LO signal are generated, thereby providing a more reliable signal output.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is an example schematic view of a photonic RF mixer using a conventional Mach-Zehnder modulator;

FIGS. 2 to 5 are graphs showing the variation in the IF signal according to the bias of a photonic RF mixer using a conventional Mach-Zehnder modulator;

FIG. 6 is an example schematic view of a silicon Mach-Zehnder modulator-based photonic RF mixer of the disclosure;

FIG. 7 is an enlarged cross-sectional view of the Mach-Zehnder modulator of FIG. 6;

FIG. 8 is a simplified diagram of FIG. 6;

FIG. 9 is a simulation result view showing the harmonic signals of the RF signal and LO signal generated due to the voltage-dependent capacitance of the PN junction; and

FIG. 10 is a simulation result view showing the output IF power of a photonic RF mixer and the variation in IF power according to the bias of the Mach-Zehnder modulator.

### DETAILED DESCRIPTION

Hereinafter, some embodiments of the present disclosure will be described in detail with reference to exemplary drawings. When assigning reference numerals to components in each drawing, identical components may be assigned the same numerals, as much as possible, even if they are shown in different drawings. Furthermore, when describing the present embodiments, detailed descriptions of related known structures or functions may be omitted if they are deemed to obscure the gist of the present technical concept. When terms such as "include," "have," and "consist of" are used herein, additional components may be added, unless "only" is used. When a component is expressed in the singular, it may also include plurals, unless otherwise explicitly stated.

Furthermore, terms such as first, second, A, B, (a), and (b) may be used to describe the components of the present disclosure. These terms are intended only to distinguish the components from other components and do not limit the nature, order, sequence, or number of the components.

In a description of the positional relationship between components, if two or more components are described as being "connected," "coupled," or "linked," it should be understood that the two or more components may be directly "connected," "coupled," or "linked," but that the two or more components may also be "connected," "coupled," or "linked" by being further "interposed" with another component. Here, another component may be included in one or more of the two or more components being "connected," "coupled," or "linked."

In a description of the temporal relationship between components, their operating methods, or their manufacturing methods, for example, if the temporal or chronological relationship is described as "after," "following," "next to," or "before," then non-continuous cases may be included, as long as "immediately" or "directly" is not used.

Meanwhile, when numerical values or corresponding information (e.g., levels, etc.) for components are mentioned, even without separate explicit description, the numerical values or corresponding information may be interpreted as including an error range that may occur due to various factors (e.g., process factors, internal or external impact, noise, etc.).

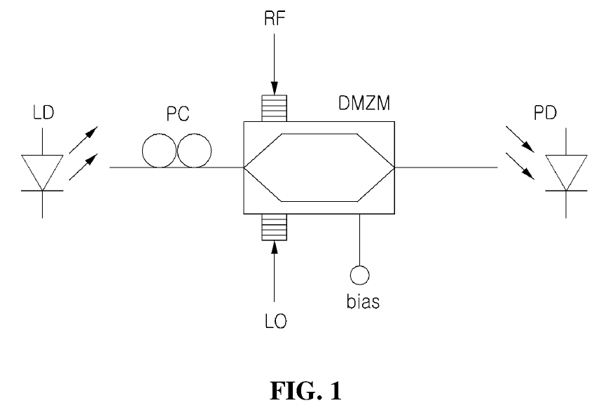

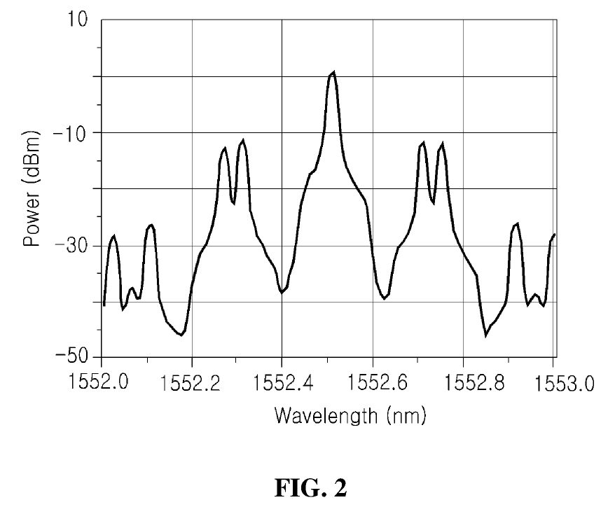

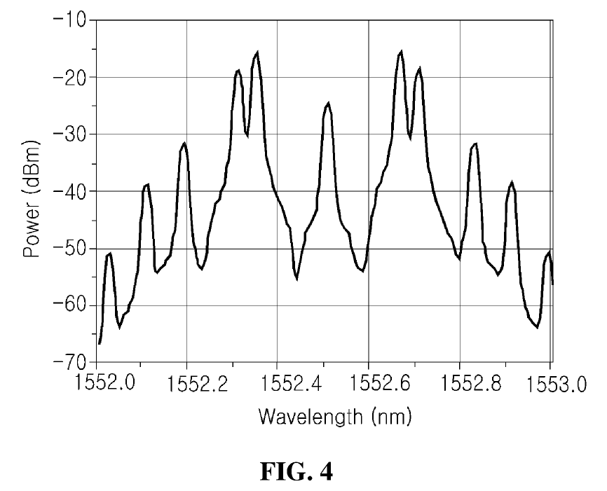

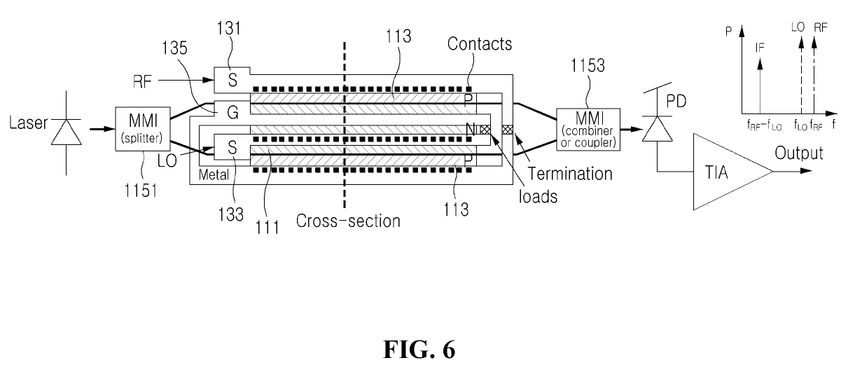

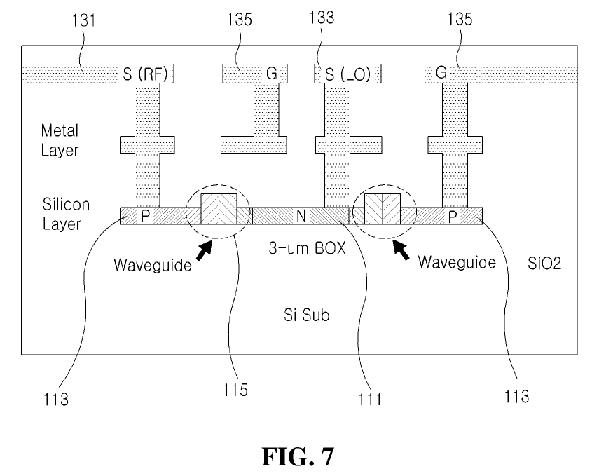

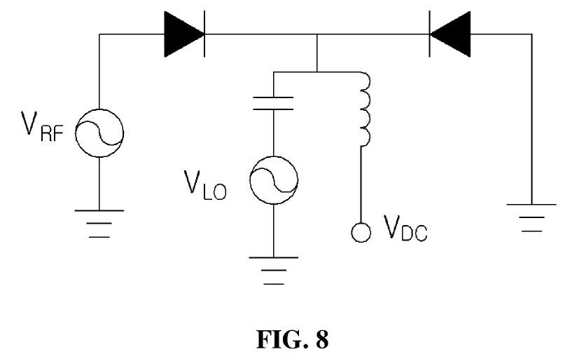

FIGS. 1 to 8 illustrate an embodiment of a silicon Mach-Zehnder modulator-based photonic RF mixer of the disclosure. FIG. 1 is an example schematic view of a photonic RF mixer using a conventional Mach-Zehnder modulator, FIGS. 2 to 5 are graphs showing the variation in the IF signal according to the bias of a photonic RF mixer using a conventional Mach-Zehnder modulator, FIG. 6 is an example schematic view of a silicon Mach-Zehnder modulator-based photonic RF mixer of the disclosure, FIG. 7 is an enlarged cross-sectional view of the Mach-Zehnder modulator of FIG. 6, and FIG. 8 is a simplified diagram of FIG. 6. Hereinafter, a silicon Mach-Zehnder modulator-based photonic RF mixer of the disclosure will be described in detail using FIGS. 1 to 8.

FIG. 1 is an example schematic view of a photonic RF mixer using a conventional Mach-Zehnder modulator, and FIGS. 2 to 5 are graphs showing the variation in the IF signal according to the bias of a photonic RF mixer using a conventional Mach-Zehnder modulator. Conventional photonic RF mixers using a Mach-Zehnder modulator, as shown in FIG. 1, either input a desired RC signal and an LO signal for down-conversion or up-conversion into each arm waveguide of the Mach-Zehnder modulator, or use two Mach-Zehnder modulators simultaneously to input an RF signal to one Mach-Zehnder modulator and an LO signal to the other.

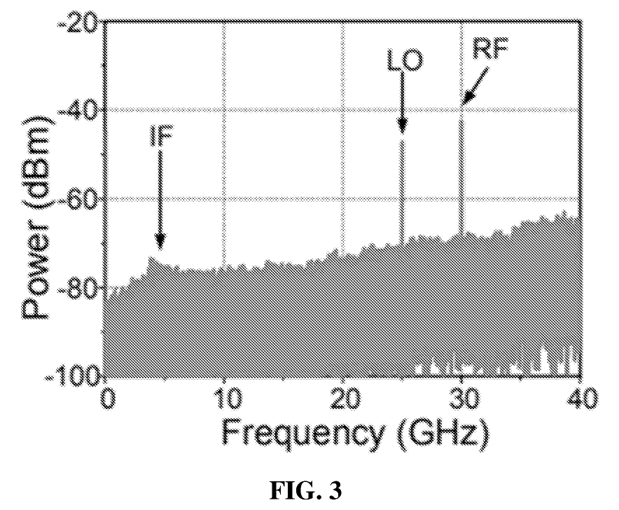

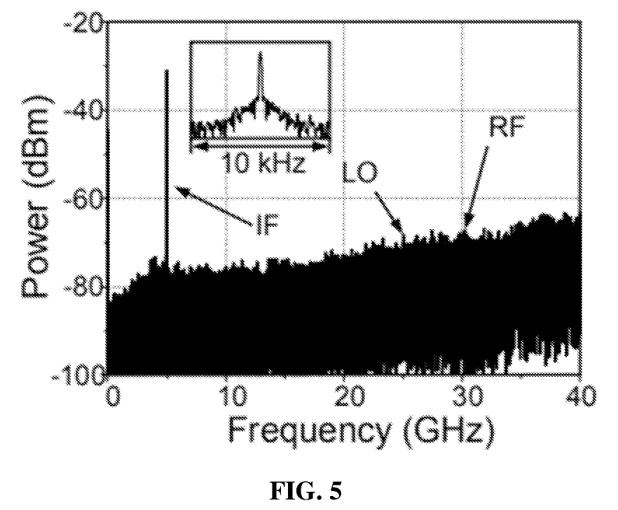

However, these methods result in significant differences in the power of the IF signal after conversion depending on the bias position of the Mach-Zehnder modulator, as illustrated in FIGS. 2 to 5. FIG. 3 shows the power of each signal when the optical bias of the Mach-Zehnder modulator is at the quadrature point, and FIG. 5 shows the power of each signal when the optical bias of the Mach-Zehnder modulator is at the peak or null point.

That is, referring to FIGS. 2 to 5, the IF signal exhibits significant differences depending on the optical bias, and this, in turn, can be interpreted as a significant dependence of the RF mixer's conversion gain on the optical bias of the Mach-Zehnder modulator.

Therefore, to overcome the problems of the related art described above, the disclosure proposes a silicon Mach-Zehnder modulator-based photonic RF mixer, as illustrated in FIG. 6, and this enables explanation about a photonic RF mixer that utilizes the structure of a Mach-Zehnder modulator, which reduces dependence on optical bias while simultaneously achieving conversion gain similar to conventional methods.

A silicon Mach-Zehnder modulator-based photonic RF mixer (1) according to an embodiment of the disclosure is formed by a stacked structure of a plurality of silicon lamination parts (11) and a plurality of metal lamination parts (13), as illustrated in FIG. 6.

The plurality of silicon lamination parts (11) are formed by stacking three silicon layers, more specifically, including a first silicon layer (111), a second silicon layer (113), and a third silicon layer (115). In an embodiment of the disclosure, a plurality of silicon lamination parts (11) are formed as an optical waveguide composed of two layers, which are a silicon layer doped with N and a silicon layer doped with P, and may include optical input/output terminals at both ends. This is because, since one embodiment of the disclosure takes the form of a Mach-Zehnder modulator, an optical splitter and an optical coupler (or coupler) must be provided at both ends of the optical waveguide.

The first silicon layer (111) may be formed to include silicon doped with N. More specifically, the first silicon layer (111) may be formed to include mixed silicon, which is formed by mixing Group V impurities (such as phosphorus or arsenic) into silicon for doping with N.

The second silicon layer (113) may be formed to include silicon doped with P. More specifically, the second silicon layer (113) may be formed to include mixed silicon, which is formed by mixing Group III impurities (such as boron) into silicon for doping with P.

The third silicon layer (115) can be defined as an optical waveguide formed using the surface where the first silicon layer (111) and the second silicon layer (113) meet. Since the first silicon layer (111) and the second silicon layer (113) are doped with N and P, respectively, a difference in refractive index occurs; therefore, the optical waveguide at the point where the two layers meet can be defined as the third silicon layer (115) in an embodiment of the disclosure.

In an embodiment of the disclosure, an optical splitter (1151) and an optical coupler (1153) may be formed to be connected to each end of the third silicon layer (115). This is because, as described above, the disclosure takes the form of a Mach-Zehnder modulator.

The plurality of silicon lamination parts (11), formed by stacking the first to third silicon layers (111 to 115) described above, may be formed to form the disclosure in an NPN or PNP configuration, depending on the stacking order.

The NPN configuration refers to a configuration in which silicon layers are stacked in an N-P-N order, and in the disclosure, as described above, the first silicon layer (111) is doped in an N configuration and the second silicon layer (113) is doped in a P configuration, which thus means a structure stacked as a first silicon layer (111) - a second silicon layer (113) - a first silicon layer (111). At this time, two third silicon layers (115) may be formed.

The PNP configuration refers to a configuration in which silicon layers are stacked in a P-N-P order, and in the disclosure, as described above, the first silicon layer (111) is doped in the N-type and the second silicon layer (113) is doped in the P-type, which thus means a structure stacked as a second silicon layer (113) - a first silicon layer (111) - second silicon layer (113). At this time, two third silicon layers (115) may be formed.

The plurality of metal lamination parts (13) are formed by stacking three metal layers, more specifically, including a first metal layer (131), a second metal layer (133), and a third metal layer (135). In an embodiment of the disclosure, the metal lamination part (13) may include a metal layer that guides an RF signal, a metal layer that guides an LO signal, and a metal layer connected to a ground.

The first metal layer (131) is defined as a layer through which RF signals are guided.

The second metal layer (133) may be defined as a layer through which LO signals are guided.

The third metal layer (135) may be formed to enable a ground to be connected. The third metal layer may serve as a grounding layer to ensure stable guidance of RF and LO signals within the metal layer.

Furthermore, the stacked structure of the metal lamination parts (13) of the disclosure may vary depending on the type of silicon lamination parts (11). As described above, the silicon lamination parts (11) are formed in an NPN or PNP configuration.

First, if the silicon lamination part (11) is formed in an NPN configuration, the first metal layer (131) of the disclosure is formed to reside on the first N silicon layer. In other words, the first metal layer (131) of the disclosure may be formed on the upper part of the first first silicon layer (111). The first metal layer (131) of the disclosure may be connected to the first first silicon layer (111) by a metal contact.

Furthermore, the second metal layer (133) of the disclosure is formed on the P silicon layer. Specifically, the second metal layer (133) may be formed on the upper part of the second silicon layer (113). The second metal layer (133) of the disclosure may be connected to the second silicon layer (113) by a metal contact.

Additionally, the third metal layer (135) of the disclosure is formed over the second N silicon layer, and specifically, the third metal layer (135) may be provided on the upper part of the second first silicon layer (111). The third metal layer (135) of the disclosure may be connected to the second first silicon layer (111) by a metal contact.

Furthermore, as illustrated in FIGS. 6 and 7, the third metal layer (135) may be further provided between the first metal layer (131) and the second metal layer (133), and additional layers may be provided as needed.

In another embodiment, when the silicon lamination part (11) is formed in a PNP configuration, the first metal layer (131) of the disclosure is formed over the first P silicon layer. In other words, the first metal layer (131) of the disclosure may be provided on the upper part of the first second silicon layer (113). The first metal layer (131) of the disclosure may be connected to the first second silicon layer (113) by a metal contact.

Furthermore, the second metal layer (133) of the disclosure may be formed over the N silicon layer, and specifically, the second metal layer (133) may be provided on the upper part of the first silicon layer (111). The second metal layer (133) of the disclosure may be connected to the first silicon layer (111) by a metal contact.

Furthermore, the third metal layer (135) of the disclosure may be formed over the second P silicon layer, and specifically, the third metal layer (135) may be provided on the upper part of the second second silicon layer (113). The third metal layer (135) of the disclosure may be connected to the second silicon layer (113) by a metal contact.

Furthermore, as illustrated in FIGS. 6 and 7, the third metal layer (135) may be further provided between the first metal layer (131) and the second metal layer (133), and additional layers may be provided as needed.

A silicon Mach-Zehnder modulator-based photonic RF mixer (1) according to an embodiment of the disclosure, having the configuration described above, operates as follows.

First, the photonic RF mixer (1) of the disclosure acquires an optical signal using a laser, and once the optical signal is acquired using the laser, the photonic RF mixer (1) acquires an arbitrary DC voltage that may reverse bias the NPN or PNP silicon lamination part (11) using the DC voltage input of the metal layer through which the LO signal is guided.

Furthermore, the photonic RF mixer (1) receives the LO signal using the LO signal input of the second metal layer (133), receives the RF signal using the RF signal input of the first metal layer (131), and outputs the signal through an optical output terminal.

The silicon Mach-Zehnder modulator-based photonic RF mixer (1) according to an embodiment of the disclosure uses the acquired DC voltage to reverse bias the PN junction of the NPN or PNP silicon lamination part (11).

Furthermore, the first PN junction in the silicon layer is affected by both the RF signal and the LO signal, wherein since the PN junction acts as a nonlinear voltage-dependent capacitor, harmonic components of both the RF and LO signals are generated. This signal is unaffected by the optical bias of the Mach-Zehnder modulator.

The harmonic components appear as the optical output of the Mach-Zehnder modulator, which can function as an optical RF mixer.

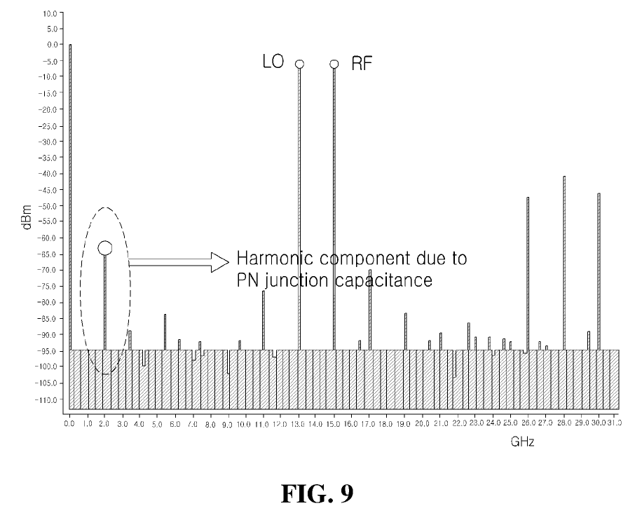

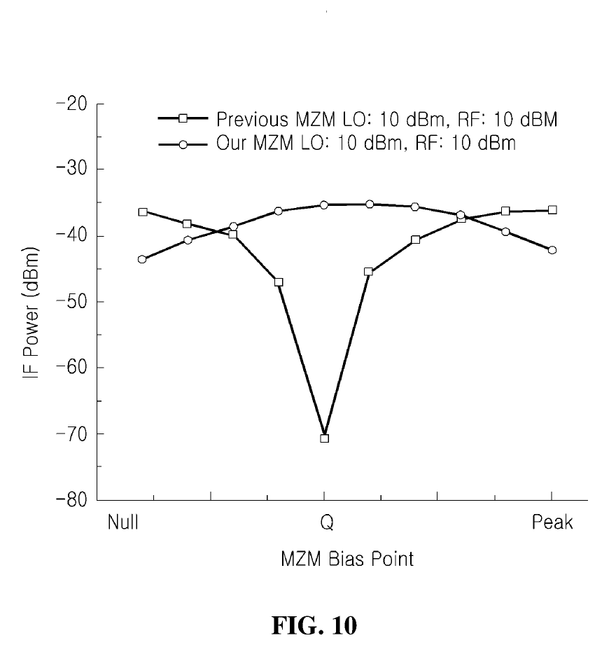

FIG. 9 is a simulation result view showing the harmonic signals of the RF signal and LO signal generated due to the voltage-dependent capacitance of the PN junction, and FIG. 10 is a simulation result view showing the output IF power of a photonic RF mixer and the variation in IF power according to the bias of the Mach-Zehnder modulator.

The results of a detailed simulation of the operating principle described above are shown in FIGS. 9 and 10.

FIG. 9 shows the results of a Fourier transform of the electrical signal generated from the first PN voltage after the RF and LO signals are input, in the frequency domain. FIG. 9 confirms that the electrical signal contains harmonic components of the RF and LO signals.

In addition, FIG. 10 is the result of comparing the output IF signal power (red) of a conventional Mach-Zehnder modulator with the output IF signal power (blue) of a photonic RF mixer using the Mach-Zehnder modulator of the disclosure when the RF and LO signals are input. Referring to FIG. 10, the power of the photonic RF mixer of the disclosure is less sensitive to bias than that of the conventional Mach-Zehnder modulator.

The above description merely exemplifies the technical concepts of the disclosure, and those skilled in the art will appreciate that various modifications and variations can be made without departing from the essential characteristics of the disclosure. Therefore, the embodiments disclosed herein are intended to illustrate, rather than limit, the technical concepts of the disclosure, and these embodiments do not limit the scope of the disclosure. The scope of protection of the disclosure should be construed in accordance with the following claims, and all technical concepts within the scope equivalent thereto should be construed as being included within the scope of the disclosure.

### Explanation of reference numerals

1: silicon Mach-Zehnder modulator-based photonic RF mixer

11: silicon lamination part

13: metal lamination part

111: first silicon layer

113: second silicon layer

115: third silicon layer

131: first metal layer

133: second metal layer

133: third metal layer

1151: optical splitter

1153: optical coupler

What is claimed is:

1. A silicon Mach-Zehnder modulator-based photonic RF mixer, comprising:
a plurality of silicon lamination parts; and
a plurality of metal lamination parts,
wherein one end of the plurality of silicon lamination parts is connected to an optical splitter, and another end of the plurality of silicon lamination parts is connected to an optical coupler, and
wherein the plurality of metal lamination parts comprises:
a first metal layer through which an RF signal is guided;
a second metal layer through which an LO signal is guided; and
a third metal layer through which a ground is connected.

2. The silicon Mach-Zehnder modulator-based photonic RF mixer of claim 1,
wherein the plurality of silicon lamination parts comprises:
a first silicon layer doped with N;
a second silicon layer doped with P; and
a third silicon layer configured to define an optical waveguide using surfaces where the first and second silicon layers contact each other, and
wherein one end of the third silicon layer is connected to the optical splitter, and another end of the third silicon layer is connected to the optical coupler.

3. The silicon Mach-Zehnder modulator-based photonic RF mixer of claim 2, wherein the first silicon layer is defined by mixing a Group 5 impurity with silicon, the second silicon layer is defined by mixing a Group 3 impurity with silicon, and the plurality of silicon lamination parts is stacked in an NPN configuration in an order of the first silicon layer, the second silicon layer, and a second first silicon layer, or in a PNP configuration in an order of a first second silicon layer, the first silicon layer, and the second silicon layer.

4. The silicon Mach-Zehnder modulator-based photonic RF mixer of claim 3, wherein if the plurality of silicon lamination parts is of the NPN configuration, the first metal layer is disposed on one side of the first silicon layer, and if the plurality of silicon lamination parts is of the PNP configuration, the first metal layer is disposed on one side of the first second silicon layer, and the first metal layer is connected to a silicon layer located underneath by a metal contact.

5. The silicon Mach-Zehnder modulator-based photonic RF mixer of claim 4, wherein if the plurality of silicon lamination parts is of the NPN configuration, the second metal layer is disposed between the first silicon layer and the second silicon layer, and if the plurality of silicon lamination parts is of the PNP configuration, the second metal layer is disposed between the first second silicon layer and the first silicon layer, and the second metal layer is connected to a silicon layer located underneath by a metal contact.

6. The silicon Mach-Zehnder modulator-based photonic RF mixer of claim 5, wherein RF signals are input only to the first metal layer, and a bias star is connected to one side of the second metal layer to enable DC voltage and LO signals to be input simultaneously to the second metal layer.

7. The silicon Mach-Zehnder modulator-based photonic RF mixer of claim 6, wherein if the plurality of silicon lamination parts is of the NPN configuration, the third metal layer is disposed on one side of the second first silicon layer, and if the plurality of silicon lamination parts is of the PNP configuration, the third metal layer is disposed on one side of the second silicon layer, and the third metal layer is connected to a silicon layer located underneath by a metal contact.

8. The silicon Mach-Zehnder modulator-based photonic RF mixer of claim 7, wherein the third metal layer is further disposed between the first metal layer and the second metal layer.
